(19) United States
(12) Patent Application Publication
(10) Pub. No.: US 2011/0276694 A1
(43) Pub. Date: Nov. 10, 2011

(54) INFORMATION TECHNOLOGY RESOURCE MANAGEMENT

(75) Inventors: Benjamin R. Swenka, Houlton, WI (US); Paul J. Cramer, JR., Minneapolis, MN (US); Peter A. Jones, Hudson, WI (US); Patrick D. Josephson, Minneapolis, MN (US); Brent E. Worden, White Bear Lake, MN (US)

(73) Assignee: BAROMETER, INC., Minneapolis, MN (US)

(21) Appl. No.: 13/098,963

(22) Filed: May 2, 2011

Related U.S. Application Data
(60) Provisional application No. 61/331,241, filed on May 4, 2010.

(51) Int. Cl. G06F 15/173

(52) U.S. Cl. 709/226

(57) ABSTRACT

Methods and systems are disclosed to facilitate holistic management of different types of IT resources within and work associated with an IT infrastructure. In one example, a method includes defining a number of parameters related to IT resources, associating an IT resource with at least one of the parameters, and aggregating a number of IT resources as an IT infrastructure. Each of the IT resources of the IT infrastructure is associated with at least one of the parameters. In another example, a method includes defining a number of parameters related to a number of different types of IT resources, associating two or more of the parameters with one another, and aggregating the parameters in an IT resource definitional structure by which any one of the types of IT resources can be defined by associating the IT resource with at least one of the parameters.

This application claims the benefit of U.S. Provisional Application No. 61/331,241, filed May 4, 2010, the entire content of which is incorporated herein by this reference.

### TECHNICAL FIELD

This disclosure relates to managing a variety of types of information technology resources.

### BACKGROUND

Companies and other organizations employ a wide variety of techniques in an attempt to manage their information technology (IT) infrastructure. Nevertheless, management of IT service related risks (versus, e.g., system related risks) associated with the cost, quality, supply, and demand of IT services is largely absent or so fragmented as to render meaningful control or management of such risks impractical. Services are unlike discrete goods or raw materials, where there are markets and mechanisms to hedge and help offset risk. Some companies have started to leverage supply chain best practices to help offset the risk of procuring services by implementing vendor management groups. However, most tools available to support this new trend focus on IT services transactions and may provide few or inadequate mechanisms to manage cost, quality, supply, and demand risks.

Additionally, companies often employ a highly fragmented approach to managing different types of IT resources within their IT infrastructure. A company may employ one or more systems to manage people, other systems to manage hardware and software systems, and additional systems to manage projects and other IT service related activities. The organization of the management of the IT infrastructure within a company (or other organization) is often so fragmented, in fact, that managers, executives, and other stake holders are not even aware of all of the IT resources the IT infrastructure of the company includes or how various resources are related to one another or are allocated within the overall infrastructure.

### SUMMARY

In general, this disclosure is directed to methods and systems that are configured to facilitate holistic management of different types of IT resources within and work associated with an IT infrastructure.

In one example, a method includes defining a number of parameters related to IT resources, associating an IT resource with at least one of the parameters, and aggregating a number of IT resources as an IT infrastructure. Each of the IT resources of the IT infrastructure is associated with at least one of the parameters.

In another example, an information technology resource management system includes at least one programmable processor and computer-readable storage medium. The computer-readable storage medium stores instructions causing the programmable processor to execute a systems module in which at least one IT system is defined at least by at least one parameter selected from a plurality of predetermined parameters related to IT resources. The instructions stored on the computer-readable storage medium also cause the programmable processor to execute a people module in which at least one person is defined at least by at least one parameters selected from the plurality of predetermined parameters. The instructions stored on the computer-readable storage medium also cause the programmable processor to execute a work module in which a project is defined at least as one or more changes to at least one IT system facilitated by at least one person.

In another example, an information technology resource management system includes means for defining a plurality of parameters related to IT resources, means for associating an IT resource with at least one of the parameters, and means for aggregating a plurality of IT resources as an IT infrastructure. Each of the IT resources of the IT infrastructure is associated with at least one of the parameters.

In another example, computer-readable storage medium stores instructions for causing a programmable processor to define a plurality of parameters related to IT resources, associate an IT resource with at least one of the parameters, and aggregate a plurality of IT resources as an IT infrastructure. Each of the IT resources of the IT infrastructure is associated with at least one of the parameters.

In another example, a method includes defining a number of parameters related to a number of different types of IT resources, associating two or more of the parameters with one another, and aggregating the parameters in an IT resource definitional structure by which any one of the types of IT resources can be defined by associating the IT resource with at least one of the parameters.

The details of one or more examples are set forth in the accompanying drawings and the description below. Other features, objects, and advantages of the disclosed examples will be apparent from the description and drawings, and from the claims.

### BRIEF DESCRIPTION OF DRAWINGS

FIG. 1 is a block diagram illustrating an example information technology resource management (ITRM) system.

FIG. 2 is a flowchart illustrating an example method of managing a number of IT resources.

FIGS. 3-6 are example maps generated by an ITRM system to visually represent different elements of an IT infrastructure and associations between the elements.

FIG. 7 is a schematic diagram of an example ITRM system architecture in which an ITRM system employed by a company is located on an internal corporate network.

FIG. 8 is a schematic diagram of an example ITRM system architecture in which ITRM systems employed by multiple companies are located on a network external to the infrastructures of both of the companies.

FIG. 9 is a flowchart illustrating an example method for generating an IT resource definitional structure that is generic to a number of different types of IT resources.

### DETAILED DESCRIPTION

The following examples include methods and systems that are configured to enable IT managers and other interested users within an organization to take a holistic approach to managing the IT resources within and the work associated with an IT infrastructure. The following examples organize a variety of different types of IT resources and the work associated with these resources according to a common structure. The organizational structure of the IT resources and the work associated with these resources is predefined, but may also evolve over time as more is learned about the function and relationships between different resources. However, at any given point in time, the various types of IT resources and the work associated with these resources are defined based on the same organized structure. The common definitional structure by which various types of IT resources are defined forms the foundation of a holistic IT infrastructure management approach that provides users with visibility of the IT infrastructure and enables them to compare, relate, and match (e.g. determine relevancy between) different types of IT resources to one another, define changes to IT resources within the IT infrastructure, and assign IT resources to various types of work (e.g. jobs and projects).

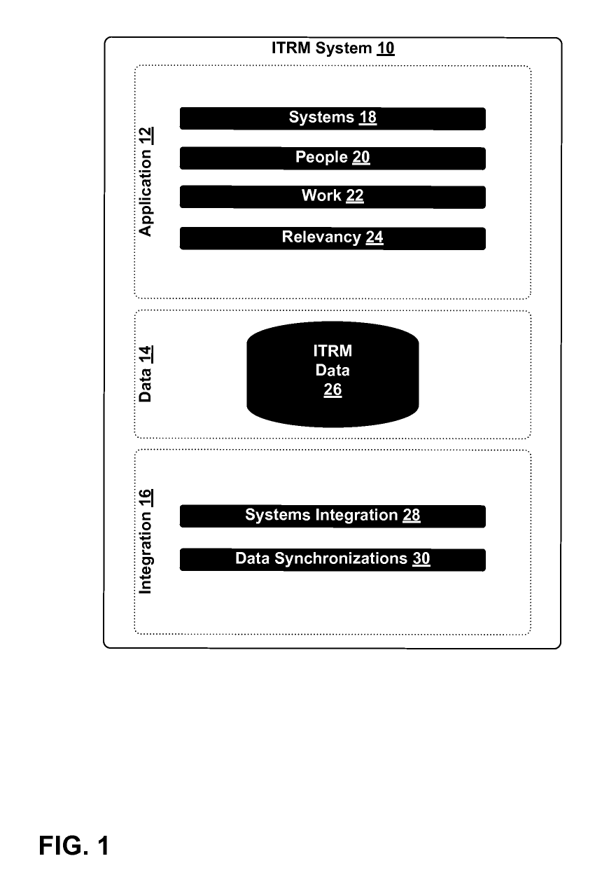

FIG. 1 is a block diagram illustrating example information technology resource management (ITRM) system 10 including application layer 12, data layer 14, and integration layer 16. Application layer 12 includes systems 18, people 20, work 22, and relevancy 24 applications. Data layer 14 includes ITRM data 26. Integration layer 16 includes systems integrations 28 and data synchronizations 30.

ITRM system 10 is configured to define a number of parameters related to IT resources and associate IT resources with at least one of the parameters. ITRM system may also aggregate the IT resources as an IT infrastructure, in which each of the IT resources of the IT infrastructure is associated with at least one of the parameters. The IT resources that comprise the IT infrastructure defined by ITRM system 10 may include a number of different types of resources, including, e.g., people and systems. In the following examples, systems will primarily include software-based systems. However, in other examples, ITRM system 10 may also manage IT hardware system resources. IT people resources may refer to people that are internal to the organization employing ITRM system 10, e.g. employees. Additionally, people may refer to external people, including, e.g., external contractors.

A wide variety of parameters that relate to various types of IT resources may be defined in ITRM system 10 and associated with IT resources, e.g. associated with systems using systems application 18 and/or with people using people application 20. For example, each person and system defined within ITRM system 10 may be associated with one or more technologies, skills, and standards.

The technologies parameter refers to foundation technologies upon which different types of IT systems are based or depend. Technologies may include, e.g., various types of platforms, frameworks, languages, or other foundational technologies, including Java, JavaScript, Microsoft .NET Framework, VB Script, Perl, ASP .NET, ODBC, and the like. Technologies may also include, e.g., various off-the-shelf software systems, including Microsoft Windows and Windows Server, Microsoft BackOffice Server, Microsoft SQL Server, Apache HTTP Server, IBM WebSphere, Oracle Database and Enterprise Repository, BEA AquaLogic, WebLogic, and the like.

The skills parameter refers to skills possessed by people trained to work on IT systems or provide other IT related services, and which may be necessary to support various other types of IT resources, e.g., IT systems. In some examples, skills may represent a combination of particular types of technologies and particular roles taken on by people in the delivery of a service. For example, skills that may be associated with an IT resource of an IT infrastructure defined and managed by ITRM system 10, e.g. associated with a system using systems application 18 and/or associated with a person using people application 20, may be .NET Architecture or Development, ASP Architecture or Development, Agile Administration, IBM WebSphere Administration, and the like. Skills may also be more directed toward various types of roles that are generic to any particular technology. For example, skills that may be associated with IT system resources in ITRM system 10 using systems application 18 and/or associated with people using people application 20 may be communications, configuration management, business intelligence, issue management, succession planning, and the like.

The standards parameter refers to technology standards upon which IT technologies and/or IT resources, e.g. IT systems are based or depend. In some examples, standards are associated with and promulgated by industry organizations that generally operate independent of particular types of technologies or IT systems, e.g. the International Organization for Standardization (ISO) or the Internet Engineering Task Force (IETF), including, e.g., ISO 8859 related to 8-bit single-byte coded graphic character sets, ISO 1989-1985 related to the COBOL programming language, Hypertext Transfer Protocol (HTTP), Hypertext Markup Language (HTML), File Transfer Protocol (FTP), and Extensible Markup Language (XML) standards, the Internet Protocol Suite (TCP/IP—RFC 1122), Common Object Request Broker Architecture (CORBA), and the like. In other examples, standards are associated with particular types of technologies and/or IT systems, including, e.g., C++and COBOL programming language specifications, Java Enterprise Edition (J2EE), Structured Query Language (SQL), Portable Document Format (PDF), and the like.

In some examples, the technologies and/or standards parameters may include technology and standards releases, respectively. Releases, technology or standards, generally refers to different versions of a particular technology or standard. For example, the Allaire ColdFusion technology may include the technology releases 1.0, 1.5, 2.0, 3.0, 3.1, 4.0, and 4.5 corresponding to different released versions of the technology. Similarly, the J2EE standard may include the standard releases 1.0, 1.2, 1.3, and 1.4 corresponding to different released versions of the standard. In addition to releases, in some examples, the technologies parameter may also include technology release sets or technology editions, both of which may represent different groupings of technology releases. Technology editions generally refer to different functional levels of a technology, e.g. professional versus enterprise or personal versus professional, each of which may include a number of technology releases. Technology release sets generally refer to groups of releases of a particular technology and may include a number of technology editions.

For example, the IBM WebSphere Application Server technology may include a base edition, a Network Deployment edition, and an Express edition. The Network Deployment edition, e.g., may include releases 5.1, 6.0, and 6.1. The IBM WebSphere Application Server technology may also include the release sets 5.1, 6.0, and 6.1, each of which may include the base edition of the corresponding release, the Network Deployment edition, and the Express edition. As such, the IBM WebSphere Application Server release set 5.1, e.g., may include the release 5.1 base edition, release 5.1 Network Deployment edition, and release 5.1 Express edition.

As will be described below, other parameters in addition to or in lieu of technologies, skills, and standards may also be defined in ITRM system 10. However, in any event, the parameters related to IT resources defined in ITRM system 10 may be organized and stored in ITRM data 26 of data layer 14, which may be accessed by any of systems 18, people 20, work 22, or relevancy 24 applications. Additionally, ITRM data 26 in general and the parameters related to IT resources in particular may also be accessed by systems integration 28 and data synchronizations 30. ITRM system 10 may employ such parameters to manage an IT infrastructure in a holistic manner by defining the resources that comprise that infrastructure and work related to the infrastructure according to a common structure, e.g. according to a common set of parameters. The IT resources defined using ITRM system 10 and stored in ITRM data 26 may be updated, changed, and added to over time by various users and through various mechanisms. However, at any given point in time, the IT resources comprising an IT infrastructure managed by ITRM system 10 may share a common set of parameters by which such resources may be compared, related, and matched with one another, changes to IT resources within the IT infrastructure may be defined, and IT resources may be assigned to various types of work (e.g. jobs and projects). ITRM data 26 may include any off-the-shelf, open source, or proprietary database or any other data storage and retrieval mechanism appropriate for storing, searching, and relating digital data.

Having defined and stored a predetermined set of IT resource parameters, the applications of ITRM system 10 may be employed to define an IT infrastructure and manage that infrastructure within the system. For example, systems application 18 may be employed to define a number of IT systems by associated each system with at least one of the IT resource parameters defined in ITRM system 10 and stored in ITRM data 26. In one example, ITRM system 10 includes the technologies, skills, and standards IT resource parameters. Systems application 18 may define a number of IT systems by associating each system with one or more technologies, skills, and standards.

For example, systems application 18 may add a billing system to the IT infrastructure managed by ITRM system 10. The billing system may be, e.g., a custom built database application in a company's IT infrastructure. Systems application 18 defines the billing system by associating the system with, e.g., the BEA WebLogic Server technology. Systems application 18 may also be used to associate the billing system with other parameters, e.g. skills and standards, independent of the association with BEA WebLogic Server. For example, systems application 18 may associate the billing system with the skill ASP Architecture and the standard SQL. In some examples, however, in addition to or in lieu of these manual associations with other parameters, the billing system added using systems application 18 may automatically inherit particular skills and standards based on the association of those parameters with the BEA WebLogic Server technology. For example, as soon as the billing system is associated with the BEA WebLogic Server technology using systems application 18, the billing system may inherit the J2EE Architecture and Development skills and the J2EE standard, which are already associated with the BEA WebLogic Server technology in ITRM system 10. In some examples, inheritance may pervade ITRM system 10 such that any element of the IT infrastructure that is associated with another element may also automatically or with user approval inherit other attributes of the associated element.

In the case of systems, the IT resource parameters defined in ITRM system 10 and associated with each system may represent characteristics of the particular system within a particular organization. As such, in some examples, ITRM system 10 may include a number of other parameters related to the implementation of a system in a company or other organization, which may be stored in ITRM data 26 and associated with each system included in an IT infrastructure managed by ITRM system 10. Additional example IT resource parameters that may be defined and stored in ITRM system 10 for association with a system in system application 20 include the organization, e.g. business unit, department, or workgroup within the company in which the system is used, particular actors, e.g. job positions or titles within the company that are associated with the system, particular organizational capabilities, e.g. internal or external services, products, or processes that the system enables the company to perform or deliver, the geographical location of the system, languages supported by the system, connections between the system and other systems within the IT infrastructure of the company, as well as any other parameters that assist in the definition of a system within the company.

In a similar fashion to IT system resources, people application 20 of ITRM system 10 may be employed to define a number of persons that provide IT services to an IT infrastructure managed by ITRM system 10. In particular, people application 20 may define IT people resources by associating each person with at least one of the IT resource parameters defined in ITRM system 10 and stored in ITRM data 26. In one example, people application 20 may define a number of IT people resources by associating each person with one or more technologies, skills, and standards.

For example, people application 20 may add a new employee of a company to the IT infrastructure managed by ITRM system 10. The employee may be, e.g., a software developer in an IT department within a company. People application 20 defines the software developer by associating the person with, e.g., the Adobe ColdFusion technology. The Adobe ColdFusion technology is associated with the ColdFusion Architecture, ColdFusion Development, and ColdFusion Project Management skills. In one example, therefore, the software developer added to the IT infrastructure with people application 20 may inherit the ColdFusion Architecture, ColdFusion Development, and ColdFusion Project Management skills associated with the Adobe ColdFusion technology. In another example, however, the software developer may not in fact have all of these skills. In such an example, therefore, people application 20 may selectively associate the software developer with the skills based on the person's actual experience. For example, people application 20 may selectively associate the software developer with only the ColdFusion Development and Project Management skills associated with the Adobe ColdFusion technology. In one example, the software developer is also associated with the BEA WebLogic Server technology and also inherits the J2EE Development skill and the J2EE standard associated with that technology.

In the case of people, the IT resource parameters defined in ITRM system 10 and associated with each person may represent characteristics of the experience level of that person. As such, in some examples, ITRM system 10 may include a number of other parameters related to personal and professional experience and educational background of people, which may be stored in ITRM data 26 and associated with each person included in an IT infrastructure managed by the ITRM system. Additional example IT resource parameters that may be defined and stored in ITRM system 10 for association with people in people application 20 include roles, responsibilities, positions, projects, education, and the like. People application may also associate IT people resources with technology or other industry certifications and/or recommendations from other people or organizations. Moreover, the experience of people may be assigned a temporal component, e.g. by associating certain experience, e.g. roles, responsibilities, positions, projects, education, and the like to certain time periods, e.g. specific years in which or a time duration over which the experience took place. In one example, the software developer added to ITRM system 10 using people application 20 may, in addition to the foregoing technologies, skills, and standards, be associated with project manager and developer roles.

In the foregoing manner, systems application 18 and people application 20 of ITRM system 10 may be employed to define a number of IT system and people resources by associating each resource with one or more IT resource parameters selected from a common group of parameters predefined in the system. Having defined the IT system and people resources using systems application 18 and people application 20, respectively, the resources and their associated parameters may be aggregated in ITRM system 10 as an IT infrastructure. Aggregating IT resources in ITRM system 10 as an IT infrastructure generally refers to generating a record of the resources and their associations in an organized manner. For example, aggregating IT resources in ITRM system 10 as an IT infrastructure may include storing the resources in a relational database or other data storage and retrieval mechanism appropriate for storing, searching, and relating the resources and the parameters associated therewith in an organized manner so as to represent an IT infrastructure. In one example, ITRM system 10 may aggregate the IT resources as an IT infrastructure in ITRM data 26, which may include a relational database for storing, searching, and relating the resources and the parameters associated therewith.

The IT infrastructure defined in ITRM system 10 may leverage the common definitional structure of the various types of IT resources that comprise the infrastructure to layer a number of functional applications onto the underlying structure. IT resource definitional structure may generally refer to data related to IT resources that is aggregated in an organized structure that is generic to a number of different types of IT resources and by which such IT resources may be defined by associating each resource with some or all of the aggregated IT resource data. As noted above, for example, ITRM system 10 may employ the common set of technologies, skills, and standards parameters associated with the IT resources that comprise the infrastructure to compare, relate, and match (e.g. determine relevancy between) different people, systems, and other types of IT resources with one another, as well as define changes to IT resources within the IT infrastructure and assign IT resources to various types of work (e.g. jobs and projects).

Referring again to the example of FIG. 1, ITRM system 10 also includes work application 22. Work application 22 of ITRM system 10 may be employed to define changes to IT resources within the IT infrastructure and assign IT resources to various types of work, including, e.g., jobs and projects. In one example, work application 22 may be employed to define a job requisition including a number of parameters generally representing an ideal candidate to fill the requisition.

For example, work application 22 may be employed to define a job requisition to fill a position within an organization that is needed for providing one or more IT services to the IT infrastructure of the organization. Referring again to the example of the custom billing system described above with reference to systems application 18, work application 22 may be employed to define a job requisition to fill a position within the company to support this billing system. Work application 22 may define the job requisition by associating it with a number of different parameters, including, e.g., some of the same parameters that are associated with the IT resources, e.g., systems and people, that comprise the IT infrastructure managed by ITRM system 10. In one example, therefore, work application 22 may define the job requisition by associating it with one or more technologies, skills, and standards relevant to the custom billing system for which support is being sought through the requisition. For example, work application may define the job requisition by associating it with the BEA WebLogic Server technology, the J2EE Architecture skill, and the J2EE standard, all of which are associated with the custom billing system defined in ITRM system 10.

In some examples, work application 22 may define the job requisition by associating it with one or more additional parameters representative of an desirable candidate to fill the requisition. For example, work application 22 may define the job requisition by associating it with one or more roles, responsibilities, educational backgrounds, and the like. In one example, work application may define the job requisition by associating it with project manager and software architect roles, which may be required to support the custom billing software in the position that is being filled by the requisition. Additionally, work application 22 may define the job requisition by associating it with parameters representative of the work and/or systems that will be involved in the position sought by the requisition. For example, work application 22 may define the job requisition by associating it with one or more IT resource systems defined in systems application 18, or capabilities, geography, or languages IT resource parameters.

In addition to defining job requisitions, work application 22 may be employed to define a project including one or more changes to the IT infrastructure managed by ITRM system 10 facilitated by one or more people. Example projects defined in work application 22 and managed in ITRM system 10 may include a system upgrade or retirement, data synchronizations and migrations, system integration, and any other of a number of types of changes that may be made to the IT infrastructure managed by system 10. In one example, a project may be defined in work application 22 as a collection of a number of job descriptions necessary to facilitate the changes to the IT infrastructure to which the project is directed. Job requisitions defined in work application 22 may represent specific requests to fill such job descriptions associated with one or more projects. In this manner, many of the parameters, e.g. technologies, skills, standards, roles, responsibilities, etc., associated with a job description will be reflected in a corresponding job requisition as described above.

In one example, work application 22 is employed to define a project to upgrade the custom billing system added to the IT infrastructure managed by ITRM system 10 using systems application 18. The upgrade of the company billing system may involve, among other changes, upgrading the release of BEA WebLogic Server used in the billing system. For example, work application 22 may define the project as including an upgrade of the BEA WebLogic Server used in the company's custom billing system from release 9.0 to release 9.1. In order to facilitate the upgrade of the BEA WebLogic Server of the billing system, one or more positions may need to be staffed. As such, work application 22 may also define the project by defining one or more job descriptions.

For example, work application 22 may define a job description for a person to manage the BEA WebLogic Server upgrade. In one example, work application 22 defines the job description in a manner similar to that employed to define a job requisition. Work application 22 may define the job description by associating it with a number of different parameters, including, e.g., one or more technologies, skills, and standards relevant to the custom billing system, and, in particular, relevant to the upgrade of the BEA WebLogic Server of the billing system. Work application 22 may also associate the job description with roles, responsibilities, educational backgrounds, and the like, which may also be sought as experience for supporting the upgrade of the BEA WebLogic Server. In this manner, work application 22 of ITRM system 10 may define a project that represents one or more changes to the IT infrastructure, e.g. one or more changes to one or more IT system resources and includes a number of job descriptions that may need to be staffed in order to facilitate completion of the project.

In addition to work application 22, ITRM system 10 of FIG. 1 also includes relevancy application 24. Relevancy application 24 is a mechanism by which ITRM system 10 may intelligently compare different data within the system, e.g. stored in ITRM data 26. In particular, relevancy application 24 may be employed to compare any type of data within ITRM system 10 to other data of the same or different type and calculate a relevancy score between the data based on the comparison. In one example, relevancy application 24 may compare a system defined in systems application 18 to a person defined in people application 20 and calculate a score of how relevant that system is to that person, or vice versa. In another example, relevancy application 24 may compare a technology defined in ITRM system 10 to a skill and calculate a score of how relevant that technology is to that skill, or vice versa. In another example, relevancy application 24 may compare two systems defined in systems application 18 to one another or two people defined in people application 20 to one another. Again, as noted above, relevancy application 24 may be employed to compare any type of data within ITRM system 10, including systems, people, parameters, projects, job requisitions, etc., to other data of the same or different type and calculate a relevancy score between the data based on the comparison. Relevancy application 24 may employ a number of different relevancy algorithms to calculate relevancy scores between data within ITRM system 10. In one example, regardless of the particular algorithm, relevancy application determines similarities and differences between the parameters associated with the data being compared as a basis for calculating a relevancy score.

As described throughout this disclosure, there are a variety of practical applications in which relevancy application 24 may be employed. In one example, relevancy application 24 may be employed to fill job requisitions and to staff projects defined in work application 22. For example, relevancy application 24 may be employed in work application 22 by comparing a job requisition to one or more people defined by people application 20 and included in the IT infrastructure managed by ITRM system 10 and calculating a relevancy score between each of the people and the job requisition. Relevancy application 24 may, for example, determine similarities and differences between the parameters associated with the job requisition and the parameters associated with each person as a basis for calculating relevancy scores between people and job requisition.

In one example, relevancy application 24 is employed to fill the job requisition defined in work application 22 for the position needed to support the custom billing system defined using systems application 18. Relevancy application 24 may, for example, compare the job requisition defined in work application 22, which is associated with the BEA WebLogic Server technology, the J2EE Architecture skill, and the J2EE standard, to the software developer defined in people application 20, whom is associated with the Adobe ColdFusion and BEA WebLogic Server technologies, the ColdFusion Development and Project Management, and J2EE Development skills, and the J2EE standard. In one example, relevancy application 24 may calculate a relevancy score between the billing system job requisition and the software developer by determining similarities and differences between the parameters associated with each. For example, relevancy application 24 may determine similarities and differences between the technologies, skills, and standards associated with the billing system job requisition and the software developer. In this example, relevancy application 24 may determine that the software developer has the BEA WebLogic Server technology and the J2EE standard in common with the billing system job requisition, but is missing the J2EE Architecture skill and also has experience with Adobe's ColdFusion that may not be relevant to the position that is being sought to support the company's billing system.

In addition to application layer 12 and data layer 14, ITRM system 10 includes integration layer 16. Integration layer 16 includes one or more mechanisms for integrating ITRM system 10 with other external systems, as well as data. In the example of FIG. 1, integration layer 16 of ITRM system 10 includes systems integration 28 and data synchronizations 30. Systems integration 28 may be employed to connect and integrate ITRM system 10 to one or more legacy or third-party systems implemented in an organization. Example systems with which ITRM system 10 may interoperate via systems integration 28 include configuration management systems (CMS), network management systems (NMS), enterprise data management systems (EDMS), enterprise portfolio management (EPM) systems, product lifecycle management (PLM) systems, and application portfolio management systems (APM). Example systems with which ITRM system 10 may interoperate via systems integration 28 include project management systems, and accounting, contracting, and billing and invoicing systems. ITRM system 10 may interoperate with other systems via systems integration 38 including, e.g., human resource management systems (HRMS), contingent workforce management (CWM) systems, talent management (TM) systems, customer relationship management system (CRM) as well as on-line job boards and social networking web sites.

In one example, people application 20 of ITRM system 10 may interoperate with a company's HRMS via systems integration 28. For example, people application 20 may interoperate with Oracle's PeopleSoft Enterprise Applications to leverage information related to IT people resources already stored and managed in PeopleSoft. In another example, people application 20 and work application 22 may integrate with online job boards and social networking web sites, including, e.g., Dice.com, Indeed.com, SimplyHired.com, LinkedIn.com, Plaxo.com, and VisualCV.com, via systems integration 28 in the process of staffing a job requisition or a project defined in ITRM system 10. In another example, systems application 18 may integrate with various configuration management systems, including, e.g., BMC Atrium, Tivioli, or CA Infrastructure Management, via systems integration 28 to leverage IT system information managed and monitored in such systems.

For example, a company may employ PeopleSoft for managing employee information, but also access Dice.com to find external contractors. In such cases, systems integration 28 and people application 20 may enable the company to compare employees to contractors for appropriateness to perform work using, e.g., relevancy application 24. Systems integration 28 may interoperate with PeopleSoft and dice.com to pull employee and contractor data from the systems. Relevancy application 24 may employ the information from systems integration in people application 20 to match one or more employees and/or contractors to, e.g., a project or job requisition in work application 22. In another example, the same company may maintain systems configurations using BMC Atrium, and manage project and program plans in Planview. In this example, the company may tie configuration management changes to project plans using systems application 18 and work application 22. In another example, the company may tie a proposed project in Planview to a job requisition in work application 22. The job requisition may then be used to find an actual employee or contractor to perform the necessary work using work application 22 and relevancy application 24, from available candidates in PeopleSoft, Dice.com, linkedin.com or similar information sources.

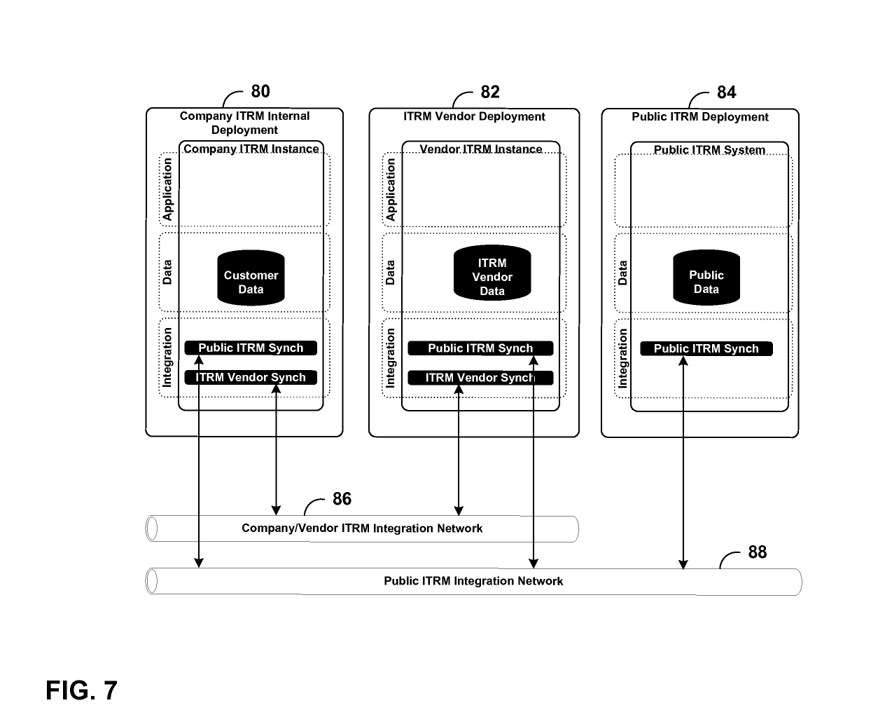

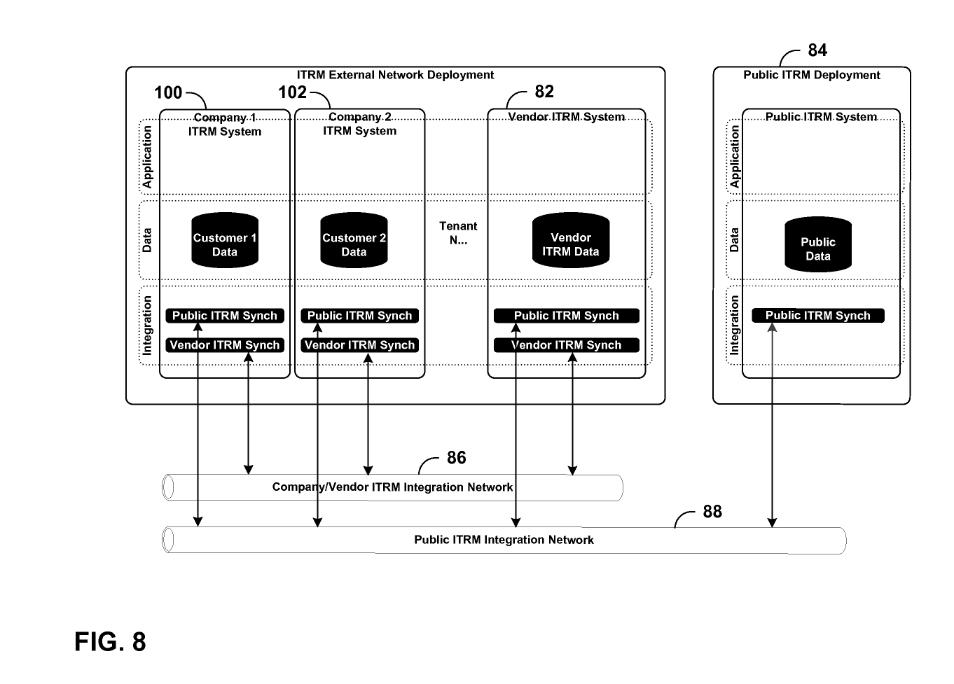

Integration layer 16 of ITRM system 10 also includes data synchronizations 30. As will be described in greater detail below with reference to FIGS. 7 and 8, it may be appropriate for ITRM system 10 to push data to and pull data from one or more external data repositories in certain implementations of the system. For example, ITRM data 26 of ITRM system 10 may include not only databases and/or other data repositories within a private IT infrastructure of a company, but may also include data drawn from or otherwise exchanged with external data repositories. In one example, ITRM data 26 of ITRM system 10 may include data from a vendor database, including, e.g., data related to contract workers supplied by a consulting company. In another example, ITRM data 26 of ITRM system 10 may include data from a public database that defines IT resources by characterizing them according to a structured set of IT resource parameters that is generic to all types and varieties of IT resources. In such examples, data synchronizations 30 of ITRM system 10 may be employed to schedule, manage, coordinate, and execute the exchange of information from system 10 to one or more external systems, as well as from the external systems to system 10.

A number of specific implementation examples of ITRM system 10 are described below with reference to FIGS. 7 and 8. However, in some examples, ITRM system 10 may be implemented on one or more of any number of different types of computing devices of various configurations. For example, ITRM system 10 may be implemented on one or more workstations, servers, or other stationary computing devices, or combinations thereof. Additionally, some portions of ITRM system 10 may be implemented on portable computing devices, including, e.g., mobile telephones, personal data assistants (PDAs), or laptop, notebook, netbook, or tablet computers.

Although the type and particular configuration of the computing device or devices on which ITRM system 10 is implemented may vary, in general, the system may include one or more programmable processors configured to execute instructions on and retrieve data from and store data on a memory to carry out one or more functions attributed to the ITRM system in this disclosure. The processors employed to execute the functions of ITRM system 10 may each include one or more processors, such as one or more microprocessors, digital signal processors (DSPs), application specific integrated circuits (ASICs), field programmable gate arrays (FPGAs), programmable logic circuitry, and the like, either alone or in any suitable combination.

The memory of the computing device or devices on which ITRM system 10 is implemented may include separate memories for storing programming instructions, ITRM resource data, resource parameters and parameter data, information related to systems and external ITRM data integrations and synchronizations, and any other information used by ITRM system 10 or another system connected to or associated with system 10. In this manner, the memory of the computing device or devices on which ITRM system 10 is implemented may store, e.g., ITRM data 26. As mentioned above, in some examples, the memory of the computing device or devices on which ITRM system 10 is implemented stores program instructions that, when executed by a processor, cause ITRM system 10 to perform the functions attributed to the system in this disclosure.

Not only may ITRM system 10 be implemented on a variety of types of hardware devices with various physical configurations, but the device or devices on which system 10 is implemented may also include a variety of software configurations. For example, ITRM system 10 may be implemented on a computing device or a number of devices that are configured to operate based on one of a variety of different operating systems, including, e.g., proprietary systems like Microsoft's Windows, Apple's MAC OS, or open source systems like UNIX, Linux, or Google's Chrome or Android.

ITRM system 10 may employ a number of different mechanisms to enable user interaction with the system. In general, however, ITRM system 10 may include a user interface (UI), including, e.g., a graphical user interface (GUI) that includes a variety of input and output controls. In some examples, ITRM system 10 may include a GUI from which users may retrieve information from and add information to system 10. The GUI of ITRM system 10 may be implemented via a variety of platforms, including, e.g., the GUI may be presented via operating system applications, web-based applications in a web browser, or combinations of different types of application platforms.

As described above, an IT infrastructure defined in ITRM system 10 may leverage a common definitional structure, i.e. common set of predefined IT resource parameters, of the various types of IT resources that comprise the infrastructure to layer a number of functional applications onto the underlying structure. The foregoing example ITRM system 10 includes a number of example applications, including systems 18, people 20, work 22, and relevancy 24 applications. However, many more applications relevant to the management of an IT infrastructure within an organization may take advantage of an underlying IT resource definitional structure as described above with reference to the example ITRM system 10 of FIG. 1. The foregoing examples and additional example applications and functions are explored further with reference to the following example method of managing IT resources.

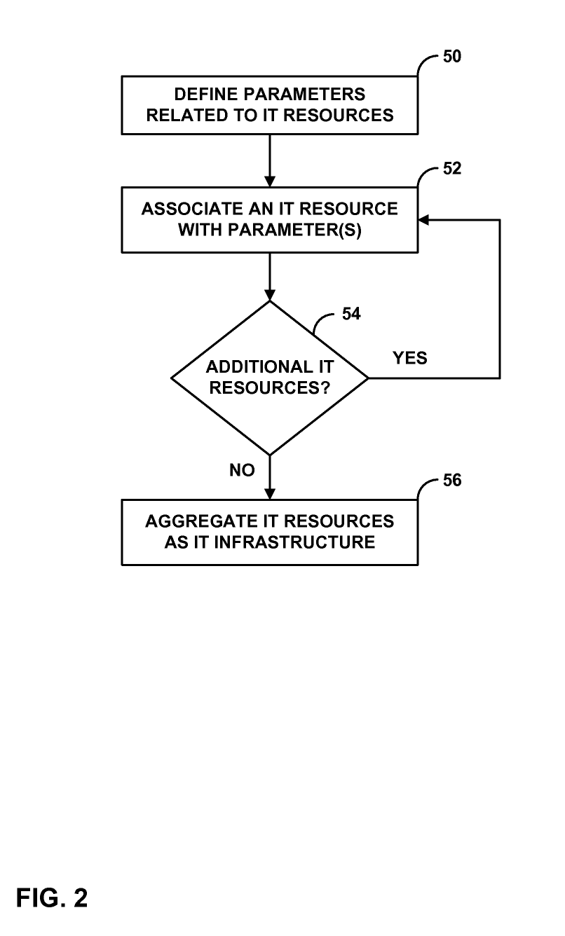

FIG. 2 is a flow chart illustrating an example method of managing IT resources. The method of FIG. 2 includes defining a number of parameters related to IT resources (50), associating an IT resource with at least one of the parameters (52), determining if there are any additional IT resources with which to associate at least one of the parameters (54), and aggregating a number of IT resources as an IT infrastructure (56).

The functions of the method of FIG. 2 for managing IT resources are described as executed by example ITRM system 10. However, in other examples, the functions associated with the method of FIG. 2 may be executed by ITRM systems with other configurations. For example, an alternative ITRM system configured to execute the functions associated with example methods of managing IT resources may be implemented in a distributed computing environment communicating over one or more private and/or public networks.

The example method of FIG. 2 includes defining a number of parameters related to IT resources (50). As explained above, a wide variety of parameters that relate to various types of IT resources may be defined in ITRM system 10, including, e.g., one or more technologies, skills, and standards. Technologies may include, e.g., various types of platforms, frameworks, languages, or other foundational technologies, as well as various off-the-shelf software systems. In some examples, skills may represent a combination of particular types of technologies and particular roles taken on by people in the delivery of a service, or skills may also be directed toward various types of roles that are generic to any particular technology. Standards may be, e.g., associated with and promulgated by industry organizations that generally operate independent of particular types of technologies or IT systems, e.g. ISO or the IETF. In other examples, however, standards may be tied to or otherwise associated with particular types of technologies and/or IT systems.

In some examples, other parameters in addition to or in lieu of technologies, skills, and standards may also be defined in ITRM system 10. However, in any event, the parameters related to IT resources defined in ITRM system 10 may be organized and stored in ITRM data 26 of data layer 14, which may be accessed by any application associated with ITRM system 10, e.g., systems 18, people 20, work 22, or relevancy 24 applications. Additionally, ITRM data 26 in general and the parameters related to IT resources in particular may also be accessed by systems integration 28 and data synchronizations 30.

Having defined a standard set of IT resource parameters, e.g. technologies, skills, and standards, ITRM system 10 may employ such parameters to manage an IT infrastructure in a holistic manner by defining the resources that comprise that infrastructure and work related to the infrastructure according to a common structure, e.g. according to a common set of parameters. In the example method of FIG. 2, therefore, ITRM system 10 may associate an IT resource with at least one of the IT resource parameters (52) stored in ITRM data 26, e.g., technologies, skills, and standards. The IT resources managed by ITRM system 10 may include, in one example, IT systems and people. As such, ITRM system 10 may be employed to associate various IT systems and people with at least one of the IT resources defined within the system and stored in, e.g., ITRM data 26. For example, systems application 18 may be employed to define a number of IT systems by associating each system with one or more technologies, skills, and standards. Additional example IT resource parameters that may be defined and stored in ITRM system 10 for association with a system using system application 20 include the organization or business unit within the company in which the system is used, particular actors, e.g. job positions or titles within the company that are associated with the system, particular organizational capabilities that the system enables the company to perform or deliver, the geographical location of the system, languages supported by the system, connections between the system and other systems within the IT infrastructure of the company, as well as any other parameters that assist in the definition of a system within the company.

In a similar fashion to IT system resources, people application 20 of ITRM system 10 may be employed to define a number of persons that provide IT services to an IT infrastructure managed by system 10. In particular, people application 20 may define IT people resources by associating each person with at least one of the IT resource parameters defined in ITRM system 10 and stored in ITRM data 26. In one example, people application 20 may define a number of IT people resources by associating each person with one or more technologies, skills, and standards. In some examples, ITRM system 10 may include a number of other parameters related to, e.g., personal and professional experience and educational background of people, which may be stored in ITRM data 26 and associated with each person included in an IT infrastructure managed by the system. Additional example IT resource parameters that may be defined and stored in ITRM system 10 for association with people in people application 20 include roles, responsibilities, positions, projects, education, and the like.

In the example method of FIG. 2, ITRM system 10 may iteratively define IT resources, e.g. IT systems and people using systems application 18 and people application 20, respectively, by checking, after each association with at least one of the IT resource parameters (52), whether there are any additional IT resources (54). If there are more IT resources, ITRM system 10 may move to the next resource and repeat the step of associating the next IT resource with at least one of the IT resource parameters (52), e.g., with one or more technologies, standards, and skills. If there are no more IT resources, ITRM system 10 may proceed with the method of FIG. 2 by aggregating a number of the IT resources within the system as an IT infrastructure (56).

Having defined the IT resources, e.g. IT system and people resources using systems application 18 and people application 20, respectively, the resources and their associated parameters may be aggregated in ITRM system 10 as an IT infrastructure (56). The IT infrastructure defined in ITRM system 10 may leverage the common definitional structure of the various types of IT resources that comprise the infrastructure to layer a number of functional applications onto the underlying structure. For example, ITRM system 10 may employ the common set of technologies, skills, and standards parameters associated with the IT resources that comprise the infrastructure to compare, relate, and match (e.g. determine relevancy between) different people, systems, and other types of IT resources with one another, as well as define changes to IT resources within the IT infrastructure and assign IT resources to various types of work (e.g. jobs and projects). A number of example applications are set forth below for managing the IT infrastructure defined in the method of FIG. 2 and leveraging the definitional structure by which the IT resources of that infrastructure are defined.

In one example, the method of FIG. 2 may include defining and staffing a number of jobs and projects related to the IT infrastructure managed by ITRM system 10. For example, work application 22 of ITRM system 10 may be employed to define a job requisition including a number of parameters representing an ideal person to fill the requisition and/or particular systems or work involved in the position sought to be filled by the requisition. In addition to defining job requisitions, work application 22 may be employed to define a project including one or more changes to the IT infrastructure managed by ITRM system 10 facilitated by one or more people. Example projects defined in work application 22 and managed in ITRM system 10 may include a system upgrade or retirement, data synchronizations and migrations, system integration, and any other of a number of types of changes that may be made to the IT infrastructure managed by system 10. In one example, a project may be defined in work application 22 as a collection of a number of job descriptions necessary to facilitate the changes to the IT infrastructure to which the project is directed. Job requisitions defined in work application 22 may represent specific requests to fill such job descriptions associated with one or more projects. In this manner, many of the parameters, e.g. technologies, skills, standards, roles, responsibilities, etc., associated with a job description will be reflected in a corresponding job requisition as described above.

A process for defining a job requisition and staffing a job position associated with the requisition may include, e.g., defining a job requisition including at least one of the IT resource parameters defined and stored in ITRM system 10 and comparing the parameters of the job requisition and parameters associated with at least one of the IT resources of the IT infrastructure. For example, work application 22 of ITRM system 10 may compare the parameters of the job requisition with parameters associated with a number of people defined in people application 20. Work application may then, in one example, select one person of the IT infrastructure based on the comparison of the parameters of the job requisition and the parameters associated with the selected person. In one example, the comparison between job requisition and people may include calculating a relevancy score between the job requisition and each of the people that are part of the comparison. For example, relevancy application 24 may be employed in work application 22 by comparing the job requisition to one or more people defined by people application 20 and calculating a relevancy score between each of the people and the job requisition. Relevancy application 24 may, for example, determine similarities and differences between the parameters associated with the job requisition and the parameters associated with each person as a basis for calculating relevancy scores between people and job requisition.

In addition to defining and staffing jobs, the method of FIG. 2 may include defining and staffing work projects related to the IT infrastructure managed by ITRM system 10. In one example, a process for defining and staffing projects may include defining a project in work application 22 that includes at least one change to the IT infrastructure and at least one job description, in which the job description includes at least one of the IT resource parameters stored in, e.g. ITRM data 26 of ITRM system 10. The changes to the IT infrastructure managed by ITRM system 10 that are executed as part of the project may include, e.g., adding, removing, or changing an IT resource that forms part of the IT infrastructure, as well as adding, removing, or changing an IT resource parameter with which one or more IT resources may be associated. In one example, work application 22 may be employed to define a project to upgrade an IT system of the IT infrastructure managed by ITRM system 10. The upgrade of the IT system may involve, among other changes, upgrading the release of one or more technologies upon which the system is based. In order to facilitate the upgrade the system, one or more positions may need to be staffed. As such, work application 22 may also define the project by defining one or more job descriptions.

In order to staff the job descriptions necessary to carry out the project, work application 22 of ITRM system 10 may define one or more job requisitions corresponding to the job descriptions and select a person for each requisition. As described above, work application 22 may define a job requisition including at least one of the IT resource parameters defined and stored in ITRM system 10. In the case of a project, the particular job requisition definition, i.e. the particular parameters associated with the job requisition, may correspond to the job description that is part of the project. Work application 22 may also compare the parameters of the job requisition with parameters associated with a number of people defined in people application 20. Work application may then, in one example, select one person of the IT infrastructure based on the comparison of the parameters of the job requisition and the parameters associated with the selected person.

In addition to selecting individual people via a job requisition for each job description, the project defined in work application 22 of ITRM system 10 may be staffed by matching a team of people defined in people application 20 to the various job descriptions that are needed for the project. In such examples, the method of FIG. 2 may also include defining, e.g. employing people application 20, a team including a number of people of the IT infrastructure managed by ITRM system 10 and comparing the parameters of each of a number of job requisitions corresponding to the job descriptions of the project and the parameters associated with each person of the team. In one example, relevancy application 24 may be employed to calculate a relevancy score between each person on the team and each job requisition corresponding to each job description of the project. Work application 22 may also, in one example, select one team of people based on the comparison of the parameters of the job requisitions and the parameters associated with each person of the selected team. In another example, parameters of a team as a whole may be compared to parameters of a project as a whole. For example, a project defined in work application 22 may require that the team has worked together in the past on a similar project, e.g. similar roles, technologies, skills, standards, etc. Such comparisons may be useful in addition to one-to-one comparisons, because this type of information does not have context at the individual person level, but only applies to the team as a collective entity and the project as a collective work unit.

In addition to defining job requisitions and projects, the method of FIG. 2 may also include determining the relevancy between two or more IT resources, parameters, or any other elements of an IT infrastructure. As noted above with reference to example ITRM system 10, relevancy functionality is a mechanism by which an ITRM system in accordance with this disclosure may intelligently compare any type of data within the system to other data of the same or different type and calculate a relevancy score between the data based on the comparison. In one example, relevancy application 24 may compare the parameters associated with each of the IT resources to one another and calculate a relevancy score based on the comparison. In general, relevancy score calculations between, e.g. two IT resources may be based on a comparison of the similarities and differences between the parameters associated with each of the resources. The relevancy score may, in some examples, be a percentage of relevance between one element of the IT infrastructure and another. However, relevancy scores may also be based on an integer scale, e.g., a scale of 1 to 5 or 1 to 10.

In one example, relevancy application 24 may employ a relevancy model by which different data within ITRM system 10 is compared and a quantitative relevancy between the data is calculated. For example, the relevancy between system A and system B of the IT infrastructure managed by ITRM system 10 may be based on the model represented by the following equation.

$$R ( A , B ) = \frac{{\sum }_{i = 1}^{n} {θ}_{i} \cdot {S}_{i} ( A , B )}{{\sum }_{i = 1}^{n} {θ}_{i}}$$

In the foregoing relevancy model, R(A, B) is the relevancy score between system A and system B, Sᵢ(A, B) are i similarity statistics, and θᵢ are the i number of IT resource parameters associated with both system A and system B. The similarity between system A and system B, or any other two or more elements of the IT infrastructure, may be based on the presence or absence of a set of attributes, e.g. the presence or absence of a set of particular IT resource parameters. In one example, for each set of IT resource parameters associated with system A and system B, presence/absence observations between the two systems may be summarized with a 2×2 frequency table, e.g. the following Table 1.

TABLE 1

System A

| | | Parameter | Parameter |
|---|---|---|---|
| | | present | absent |
| System B | Parameter present | a | b |
| | Parameter absent | c | d |

In Table 1, a is the number of parameters present in both system A and system B, b is the number of parameters present in system A and absent from system B, c is the number of parameters absent from system A and present in system B, and d is the number of parameters absent from both system A and system B. Using such a frequency table, several similarity statistics may be computed, including, e.g. a Jaccard Index, Mountford Index, and/or Sorenson Index. These similarity statistics have two common characteristics. First, the output range of these statistics is the closed interval [0, 1], i.e. the set of all real numbers that are greater than or equal to 0 and less than or equal to 1. Second, the statistics are symmetric with respect to their input. In other words, referring again to the foregoing example relevancy model, Sᵢ(A, B)=Sᵢ(B, A).

The output range of [0,1] may be beneficial as the range makes the similarity statistics employed in the relevancy model scalars and thereby allows for combining several statistics into an aggregate similarity statistic, as with the relevancy score R(A, B). The symmetry property may not, however, be desirable in some examples, as symmetry may not be appropriate or accurate in relevancy models for technology related resources, parameters, or other elements of an IT infrastructure. As such, in some examples, an adjustment may be made to the similarity statistics employed in the relevancy model to add a component of asymmetry to the measures.

In one example, to adjust symmetric similarity statistics, an asymmetric similarity factor may be introduced. One asymmetric similarity factor may be based on the premise that if system A has a higher presence of parameters that are present in system B, then system A is more similar to system B than if system A has a smaller presence of those parameters. In terms of the frequency table above, one such asymmetric similarity factor, F(A, B), may be expressed according to the following formula.

$$F ( A , B ) = \frac{a}{a + b} , where a + b > 0$$

$$or$$

$$F ( A , B ) = 0 , where a + b = 0$$

Employing the foregoing example asymmetric similarity factor, asymmetric similarity statistics may be computed by multiplying a symmetric similarity statistic, Sᵢ(A, B), e.g. Jaccard Index, Mountford Index, or Sorenson Index by the asymmetric similarity factor, F(A, B). For example, an asymmetric similarity statistic, S′ᵢ(A, B) may be computed according to the following formula.

S′ᵢ(A,B)=F(A,B)·Sᵢ(A,B)

As with the symmetric similarity statistics described above, the asymmetric similarity factor, F(A, B), has the closed interval [0, 1] as an output range. Because of this, the asymmetric similarity statistic, S′ᵢ(A, B), retains the closed interval [0, 1] as an output range. With the introduction of the asymmetric similarity factor, F(A, B), the overall relevancy model becomes:

$$R ( A , B ) = \frac{{\sum }_{i = 1}^{n} {θ}_{i} \cdot {F}_{i} ( A , B ) \cdot {S}_{i} ( A , B )}{{\sum }_{i = 1}^{n} {θ}_{i}}$$

$$or$$

$$R ( A , B ) = \frac{{\sum }_{i = 1}^{n} {θ}_{i} \cdot {S}_{i}^{′} ( A , B )}{{\sum }_{i = 1}^{n} {θ}_{i}}$$

The foregoing relevancy model for calculating the relevancy score R(A, B) is a linear function in terms of the similarity statistics, Sᵢ(A, B). The similarity statistics may not, however, exhibit a linear relationship with relevancy. To address this discrepancy, in one example, a shape parameter may be introduced to each similarity statistic. The shape parameter allows relevancy to be modeled with a whole class of functions and not just functions that are linear in terms of the similarity statistics. For example, the shape parameter may be a non-negative exponent, α, applied to the asymmetric similarity statistic, S′ᵢ(A, B), e.g. according to the following formula.

S″ᵢ(A,B)=[S′ᵢ(A,B)]^{α}

With the introduction of the shape parameter, the relevancy model becomes:

$$R ( A , B ) = \frac{{\sum }_{i = 1}^{n} {θ}_{i} \cdot {[ {F}_{i} ( A , B ) \cdot {S}_{i} ( A , B ) ]}^{α}}{{\sum }_{i = 1}^{n} {θ}_{i}}$$

$$or$$

$$R ( A , B ) = \frac{{\sum }_{i = 1}^{n} {θ}_{i} \cdot {[ {S}_{i}^{′} ( A , B ) ]}^{α}}{{\sum }_{i = 1}^{n} {θ}_{i}}$$

$$or$$

$$R ( A , B ) = \frac{{\sum }_{i = 1}^{n} {θ}_{i} \cdot {S}_{i}^{″} ( A , B )}{{\sum }_{i = 1}^{n} {θ}_{i}}$$

In the foregoing manner, or employing another relevancy model, the method of FIG. 2 may include determining the relevancy between two or more IT resources, parameters, or any other elements of an IT infrastructure. The parameters upon which the relevancy score is based may be, e.g., technologies, skills, and/or standards. In the case of people defined, e.g., in people application 20 of ITRM system 10, the parameters employed for relevancy determinations may also include roles, responsibilities, positions, projects, education, and the like. In the case of systems defined, e.g., in systems application 18 of ITRM system 10, the parameters employed for relevancy determinations may also include the organization, e.g. business unit, department, or workgroup within the company in which the system is used, particular actors, e.g. job positions or titles within the company that are associated with the system, particular organizational capabilities, e.g. internal or external services, products, or processes that the system enables the company to perform or deliver, the geographical location of the system, languages supported by the system, and connections between the system and other systems within the IT infrastructure of the company.

As noted above, the organizational structure of the IT resources and the work associated with these resources may be predefined in a managed IT infrastructure. However, the structure may also evolve over time as more is learned about the function and relationships between different resources. For example, the type and values of different IT resource parameters may be changed, removed, and added over time to improve the ability to categorize IT resources within and work related to an IT infrastructure of an organization. One way in which the definitional structure of an IT infrastructure may change and adapt over time is by soliciting input from users, including, e.g., user voting. In general, user voting may allow authorized users to provide their opinion with respect to relationships between or parameters associated with different elements of an IT infrastructure.

In one example, users of ITRM system 10 may express opinions about a relevancy score between two or more IT resources calculated by the system. For example, a user may disagree with a relevancy score calculation and enter a score that they believe is more accurate. In one example, ITRM system calculates a 90% relevancy score between system A and system B. The user, however, believes that the relevancy between system A and system B is lower. ITRM system 10 may therefore provide the user a mechanism for entering a relevancy score, e.g., as one of a number of ranges. For example, the user may indicate that system A and system B are 0-25%, 26-50%, 51-75%, or 76-100% relevant to one another. The foregoing ranges are merely illustrative and different ranges or incremental relevancy score values may be used in other examples. User voting may be used over time with varying confidence in relevancy determinations. For example, as more users vote for a particular relevancy score or similar relevancy scores between systems A and system B, ITRM system 10 may assign increasing weight to the user votes as one factor in calculating the relevancy between the two systems.

Another example of adaptation of the IT infrastructure managed by ITRM system 10 over time includes changing associations or adjusting relevancy scores between particular parameters and/or IT resource systems based on groupings of such elements as associated with IT resource people. In one example, people application 20 of ITRM system 10 defines a number of people by associating them with various parameters, as well as, in some examples, IT systems. Over time, ITRM system 10 may analyze the parameters and systems associated with some or all of the people defined in people application 20 to detect patterns of association between particular parameters and/or systems. For example, the custom billing system described above may be repeatedly found as associated in people application 20 with people that are also associated with a particular skill and a particular standard. However, the particular skill and particular standard that the people are associated with may not yet be associated with the custom billing system in system application 18 of ITRM system 10. In such examples, ITRM system 10 may change the associations or adjust relevancy scores between the custom billing system and the skill and standard based on the occurrence of these elements of the IT infrastructure as repeatedly associated together with a number of people defined in people application 20.

Thus far the applications associated with example ITRM system 10 and additional functions associated with the example method of FIG. 2 have focused on work, e.g. jobs and projects, related to an IT infrastructure within an organization, and relevancy, which may be applicable to a wide variety of tasks across various applications. However, visibility of the IT infrastructure and the common IT resource definitional structure provided by ITRM systems in accordance with this disclosure affords the opportunity for other applications and functions related to managing different types of IT resources. For example, the IT systems that form part of the IT infrastructure of an organization may be analyzed in a number of ways to determine the impact of changes to one or more systems on the infrastructure as a whole, as well as on other IT resources or parameters related thereto. In addition, the IT infrastructure and the resources and parameters included in the infrastructure may be visualized in a number of different representational formats to facilitate understanding and management of the infrastructure.

In one example, the method of FIG. 2 may also include storing an instance of an IT infrastructure at a point in time and comparing two or more instances of the IT infrastructure at two or more points in time. In the context of the example ITRM system 10 of FIG. 1, an instance of the IT infrastructure that is comprised of an aggregation of a number of IT resources may be stored as it is defined at a particular point in time. This and other “snapshots” of the IT infrastructure at different points in time may be used for comparative and analytical purposes related to managing an IT infrastructure.

There are a number of applications in which or purposes for which such functionality may be useful. For example, ITRM system 10 may use multiple snapshots to develop “what if” scenarios that simulate one or more changes to the IT infrastructure. In such prospective examples, ITRM system 10 may project the potential impact the changes to the IT infrastructure will have on, e.g., people and/or systems throughout the infrastructure, as well as to project expenditures and/or cost reductions. For example, ITRM system 10 may simulate at least one change to the IT infrastructure, including, e.g. adding, removing, or changing one of the IT systems that is included in the IT infrastructure. ITRM system 10 may then store the simulated instance of the IT infrastructure, e.g., in ITRM data 26. ITRM system 10 may analyze the impact of the simulated change to the IT infrastructure by, e.g., comparing the simulated instance of the IT infrastructure and an instance of the IT infrastructure at a point in time without the simulated change to the IT infrastructure.

The comparison may include, e.g., visualizing the differences between the simulated instance of the IT infrastructure and the instance of the IT infrastructure at the point in time without the simulated change to the IT infrastructure. For example, ITRM system 10 may illustrate the comparison between the two snapshots of the IT infrastructure as how different people are impacted by removing or upgrading a system. In one example, removing a system may call into question a person's continued employment or contract with a company or that person's current position within the company. In another example, upgrading a system may necessitate additional training for a person that supports the system, because the upgrade invokes technologies, skills, and/or standards with which the person does not have experience. The comparison executed by ITRM system 10 may illustrate effects not only on people, but also on other systems within the IT infrastructure. For example, an upgrade to one system may necessitate changes to another system that also is based or otherwise depends on a technology that is changed as part of the upgrade. In another example, removing one system from the IT infrastructure may affect another system that depends on the removed system for its operation.

Similar comparisons and analysis may be performed by ITRM system 10 in examples in which, instead of changing a system, one or more IT resource people are changed or removed from the IT infrastructure. In one example, removing a particular person from the IT infrastructure may leave a legacy IT system unsupported by anyone with experience with, e.g., the requisite technologies, skills, and/or standards upon which the legacy system is based or otherwise depends. ITRM system 10, or another ITRM system in accordance with this disclosure, may execute any other comparisons between two instances of an IT infrastructure that illustrate or otherwise represent differences and/or effects of the differences between the two instances of the infrastructure.

In another example, ITRM system 10 may use multiple snapshots of the IT infrastructure to look back at past instances of the infrastructure and compare it to the infrastructure in its current form. Such retrospective examples may be employed for data or systems recovery purposes, e.g. to regress to a previous configuration of the IT infrastructure before a significant system change was implemented. In one example employing snapshots of the IT infrastructure, ITRM system 10 may also compare two more instances of the IT infrastructure at two or more points in time in the past, e.g. to audit the infrastructure over time.

Another application of the underlying structure of example ITRM system 10 of FIG. 1 and the functions illustrated in the example method of FIG. 2 is the identification of redundant IT resources within an IT infrastructure. This may apply, in some examples, to different types of IT resources, including, e.g., systems and people. In one example, the method of FIG. 2 may also include comparing the parameters associated with each IT resource to the parameters associated with all of the other IT resources of the IT infrastructure and identifying two or more IT resources with at least one of the parameters in common as redundant IT resources.

In some examples, systems defined in, e.g., systems application 18 of ITRM system 10 may be associated with, among other parameters, capabilities of a company. As noted above, capabilities may refer to internal or external services, products, or processes that the system enables the company to perform or deliver. In some examples, capabilities of an organization may correspond in directly or indirectly to particular functionality that a system provides. In any event, a search of the IT infrastructure by ITRM system 10 may yield two or more systems that enable the delivery of redundant capabilities. For example, in an insurance company, system A and system B may be associated with the delivery of an insurance claims capability.

ITRM system 10 may be employed to investigate systems A and B further to determine whether the systems have other parameters in common. However, in the event that it is determined that system A and system B are redundant, because, e.g., they are both used in the IT infrastructure to deliver the same capability, one of the two systems may be removed from the IT infrastructure.

Another possible example of potentially redundant IT resources within the IT infrastructure managed by ITRM system 10 is a situation in which the search of the IT infrastructure comparing the parameters associated with each IT resource to the parameters associated with all of the other IT resources discovers two systems that are technologically and functionally exactly the same, e.g. the two systems share the same technologies, skills, standards, and capabilities. Ordinarily, such technologically and functionally identical systems may be removed from the IT infrastructure as redundant. However, in one example, the comparison also shows that the two systems are in two different geographical locations of a company, in which case, it may be appropriate to retain both systems in spite of their identity of technology and function.

In some examples, instead of removing an IT resource identified as redundant from the IT infrastructure managed by ITRM system 10, the snapshot functionality may be employed to simulate the infrastructure with the redundant system removed and compare the simulated infrastructure to the infrastructure without the redundant system removed. In other words, the snapshot functionality described above may be employed to analyze the effects of removing an IT resource that has been identified as redundant from the IT infrastructure. In one example, therefore, ITRM system 10 may store an instance of the IT infrastructure including any IT resources identified as redundant, e.g. in ITRM data 26. System 10 may also simulate the IT infrastructure with at least one of the redundant IT resources removed and compare the simulated instance of the IT infrastructure with the redundant IT resource removed and the instance of the IT infrastructure including the redundant IT resource.

Although the foregoing example is described in the context of identifying redundant IT resources within an IT infrastructure, other redundancies within an IT infrastructure may also be identified. For example, redundant technologies upon which one or more IT systems are based or otherwise depend may be identified within an IT infrastructure. In one example, two web based application systems within an IT infrastructure managed by ITRM system 10 employ and are associated with two different enabling web server technologies defined in the system. However, a search and analysis of the IT infrastructure by ITRM system 10 determines that although the two web server technologies are different they are based on, e.g., the same or similar standards and skills and provide, e.g., the same or similar functionality. However, the licensing cost of one of the technologies is significantly higher than the other. In such an example, it may be appropriate to retire the higher cost redundant technologies and migrate the system that uses that technology to the other lower cost web server technology. In this manner, a company or other organization may, e.g., maintain the same capabilities while reducing the cost and complexity of delivering such capabilities to its employees, vendors, or customers.

Another application of the underlying structure of example ITRM system 10 of FIG. 1 and the functions illustrated in the example method of FIG. 2 is identifying IT resources for removal from an IT infrastructure. With reference to this example, the method of FIG. 2 may therefore also include identifying an IT resource for removal from the IT infrastructure. This particular application may also relate to different types of IT resources, including, e.g., people and systems. In one example, a portion of the internal or external labor force of a company may be identified for downsizing through, e.g., layoffs or early retirement incentives. In another example, one or more IT systems may be identified for retirement. System retirement may be desirable or necessary where, e.g., the system was employed to deliver a capability no longer provided by a company or is based on one or more technologies or standards that are no longer supported or are otherwise already or becoming obsolete.

In some examples, the IT resource identified for removal may then be removed from the IT infrastructure managed by ITRM system 10. In other examples, however, ITRM system 10 may analyze the impact of, e.g., retiring an IT system before removing the system from the IT infrastructure. For example, the snapshot functionality described above with reference to comparing two or more instances of the IT infrastructure at two or more points in time may be employed to simulate the infrastructure with the system retired and compare the simulated infrastructure to the infrastructure without the system retired. In one example employing snapshots, ITRM system 10 may store an instance of the IT infrastructure including the IT system identified for retirement. System 10 may then simulate the IT infrastructure with the IT system retired and compare the simulated instance of the IT infrastructure with the IT system retired and the instance of the IT infrastructure still including the IT system.

Another application of the underlying structure of example ITRM system 10 of FIG. 1 and the functions illustrated in the example method of FIG. 2 is generating one more types and varieties of visualizations of a managed IT infrastructure. In one example employing visualizations, the method of FIG. 2 includes generating a visualization of an IT infrastructure including at least one IT resource included in the IT infrastructure. Visualizations generated by, e.g., ITRM system 10 may include a wide variety of representations of the IT infrastructure. For example, ITRM system 10 may generate a map including one or more IT resources of the IT infrastructure and the parameters associated with the IT resources.

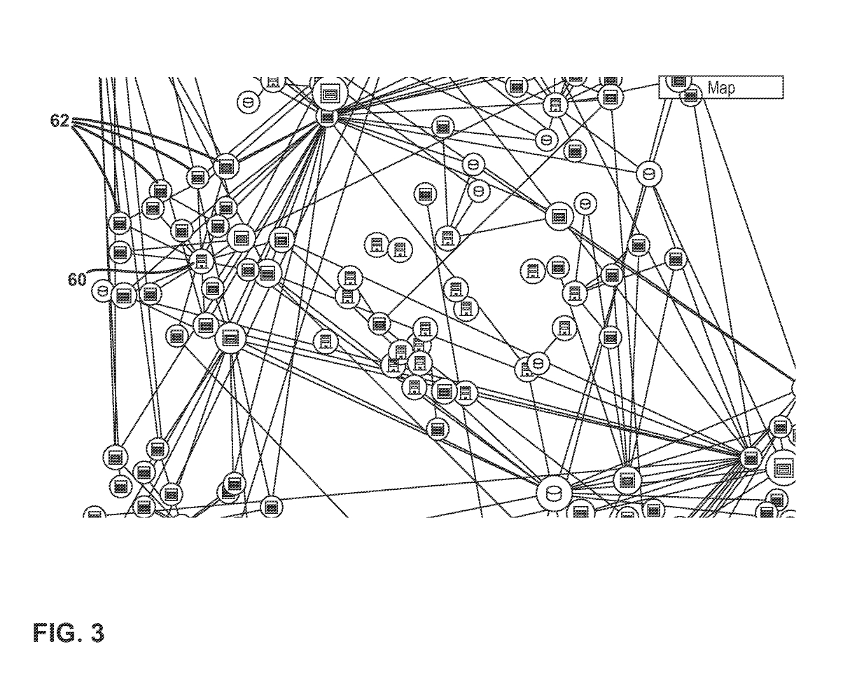

In one example, ITRM system 10 generates a map that includes a system of the IT infrastructure visually associated with an organization, e.g. business unit, department, or workgroup, of a company. For example, FIG. 3 is an example map of an IT infrastructure of a company generated by an ITRM system in accordance with this disclosure. In FIG. 3, different elements of the IT infrastructure, e.g. IT resources, parameters, and the like, are represented by different icons and associations between the elements are represented by lines connecting the elements to form a web of elements and associations. For example, an organization within the company, such as corporate IT department 60 is represented by one icon and the various elements of the IT infrastructure associated with this department within the company are illustrated as different icons surrounding corporate IT department 60. In the example map of FIG. 3, corporate IT department 60 is surrounded by and visually associated with a number of iconically represented systems 62. Although the example map of FIG. 3 is illustrated in grayscale, in some examples, the elements of the IT infrastructure may be represented in a number of colors indicative of different characteristics of each element.

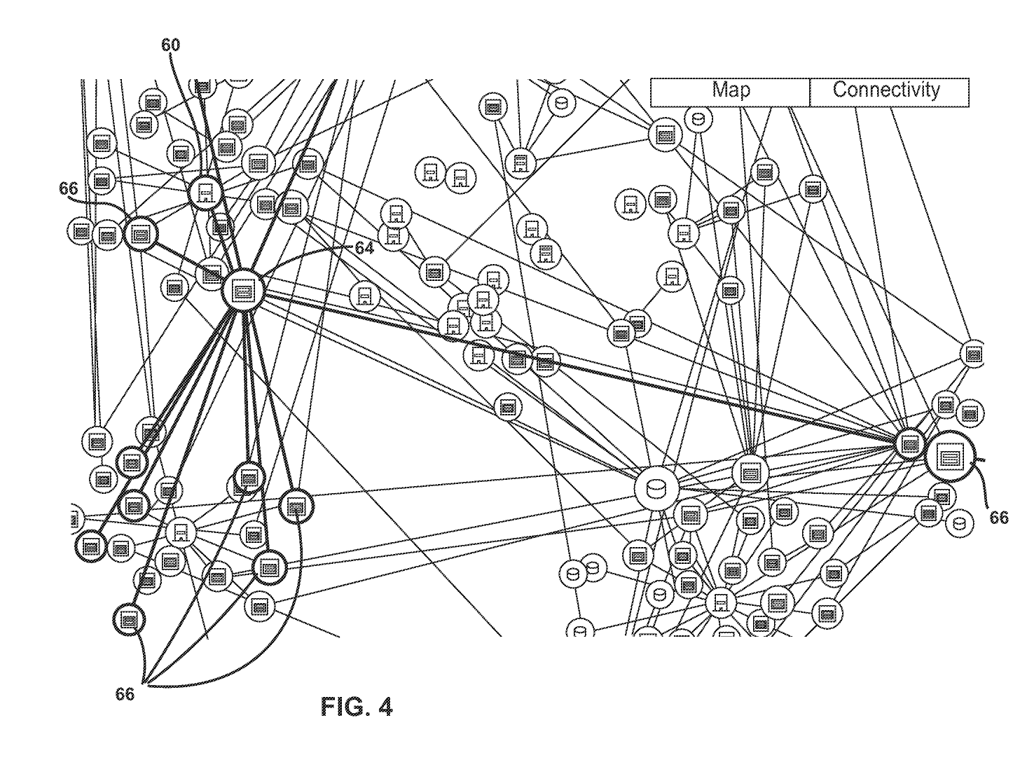

Other maps may be generated by ITRM system 10 in a manner similar to the example of FIG. 3, except that the type of element upon which the map is based may change. The map of FIG. 3 centers around different organizations within a company and elements of the IT infrastructure, e.g. systems, managed by ITRM system 10 are visually represented as associated with these organizations. In another example, however, ITRM system 10 may generate a map that centers on a particular system with other elements of the IT infrastructure visually represented as associated with that system. For example, FIG. 4 is an example map of the IT infrastructure of the company generated by ITRM system 10 showing accounting system 64 of the infrastructure visually associated with corporate IT department 60 and other systems 66. As is illustrated in the example of FIG. 4, the map generated by ITRM system 10 is adaptive such that once system 64 is selected as an element of interest, elements of the IT infrastructure not directly related to that system are visually deemphasized into the background of the map.

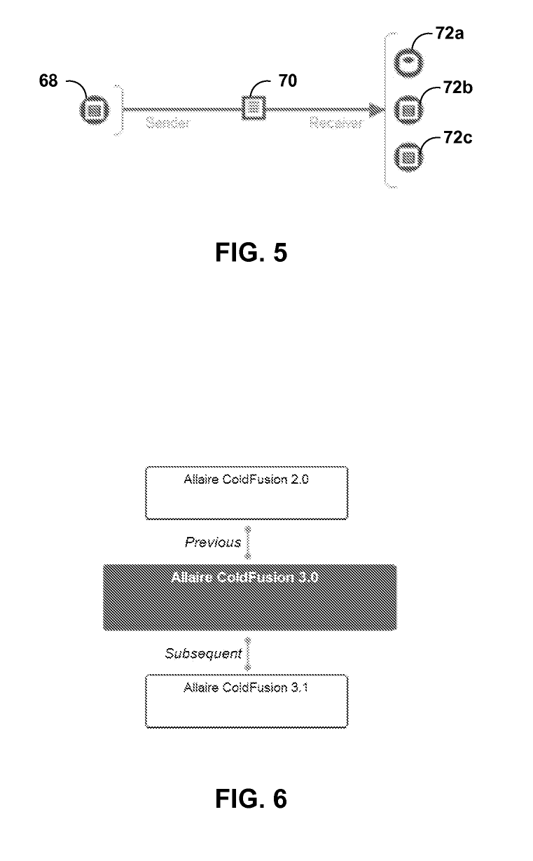

FIGS. 5 and 6 are maps of additional example visual representations of elements of an IT infrastructure managed by, e.g., ITRM system 10. In the example of FIG. 5, ITRM system 10 generates a map that includes a number of systems and a connection defined between the systems of the IT infrastructure. Connections between systems in an IT infrastructure may represent data exchange or synchronization or other forms of information exchange or integration between two or more systems. Connections may be defined by not only the type of connection, but also the mechanism or mechanisms by which the connection is executed, including, e.g. particular file protocols and/or transport mediums according to which and over which the connection is made. The map of FIG. 5 illustrates IT billing system 68 of the IT infrastructure managed by, e.g., ITRM system 10 and FTP connection 70 between the billing system and financial data store 72a, accounting system 72b, and invoicing system 72c.

FIG. 6 is an example map generated by, e.g., ITRM system 10 illustrating a number of releases of a particular technology. As described above, particular technologies defined within ITRM system 10 may include more than one release. In the example of FIG. 6, ITRM system 10 generates a map of three releases, 2.0, 3.0, and 3.1 of the Allaire ColdFusion technology, and visually illustrates the chronological relationship between the releases. Other visualization examples other than those specifically illustrated in FIGS. 3-6 may be generated by ITRM system 10, or another ITRM system in accordance with this disclosure. For example, ITRM system 10 may generate a map that includes a system visually associated with an organization and with one or both of a capability or an actor of the company. In another example, ITRM system 10 generates a map that includes a person of the IT infrastructure visually associated with one or more of a system of the IT infrastructure, a project, a position, a role, or a responsibility. In general, ITRM system 10 may generate a map that visually represents and associates any combination of elements within an IT infrastructure managed by the system.

As noted above with reference to example ITRM system 10 of FIG. 1, ITRM systems and methods of managing IT resources in accordance with this disclosure may be implemented in a variety of different types of system architectures employing a variety of computing devices. Two example system architectures are illustrated in FIGS. 7 and 8. FIG. 7 is a schematic diagram of an example ITRM system architecture in which an ITRM system employed by a company is located on an internal corporate network. FIG. 8, on the other hand, is a schematic diagram of an example ITRM system architecture in which ITRM systems employed by multiple companies are located on a network external to the infrastructures of both of the companies.

The example architecture illustrated in FIG. 7 includes company ITRM system 80, vendor ITRM system 82, and public ITRM system 84. Company ITRM system 80 and vendor ITRM system 82 are connected by company/vendor ITRM integration network 86. Company ITRM system 80 and vendor ITRM system 82 are connected to public ITRM system 84 by public ITRM integration network 88. Company ITRM system 80 may be configured in a similar manner as example ITRM system 10 described above with reference to FIG. 1. Additionally, company ITRM system 80 may include some or all of the applications described with reference to ITRM system 10 of FIG. 1, as well as the functions described with reference to the example method of FIG. 2. In the example of FIG. 7, company ITRM system 80 is deployed on a network that is internal to the company. However, company ITRM system 80 is also in communication and cooperation with vendor ITRM system 82 and public ITRM system 84 via company/vendor ITRM integration network 86 and public ITRM integration network 88, respectively.

In one example, vendor ITRM system 82 may include an ITRM system owned and/or operated by any vendor of the company. For example, vendor ITRM system 82 may be operated by a consulting company that provides IT consultants to the company and that uses the system to manage and provide work for a team of consultants employed by or otherwise associated with the consulting company. In another example, vendor ITRM system 82 may be operated by the vendor that produces and sells ITRM system 80 to the company. In another example, vendor ITRM system 82 may be another service or product supplier that does business with the company.

The example architectural implementation of FIG. 7 also includes public ITRM system 84. Public ITRM system 84 may be a publicly accessible and, in some examples, editable ITRM system that generates and stores a definitional structure, e.g. a number of different parameters with different values and associations, for organizing, aggregating, and managing a variety of different IT resources. For example, instead of defining and managing an IT infrastructure as with ITRM system 10, public ITRM system 84 may define a number of parameters that are generic to different types of IT resources and aggregate the parameters in a structure by which a wide variety of IT resources may be defined and managed.

In general, the implementation example of FIG. 7 may be employed to share and exchange information between multiple ITRM system instances, i.e. company ITRM system 80, vendor ITRM system 82, and public ITRM system 84 to more efficiently manage IT resources of an IT infrastructure. For example, in the process of defining and generating a project for upgrading a system of the IT infrastructure managed by company ITRM system 80, system 80 may search and calculate relevancy scores between the project and people defined in vendor ITRM system 82, which represent consultants that are employed or otherwise associated with the vendor. Additionally, company ITRM system 80 may leverage the definitional structure of public ITRM system 84 to define and manage the IT resources of the IT infrastructure of the company. For example, company ITRM system 80 may periodically query and synchronize data with public ITRM system 84 as IT resource parameters are changed in the public ITRM system, e.g., as technologies related to a system in the company's IT infrastructure are changed in the public ITRM system. Additionally, the company may authorize communicating changes that are made to IT resource parameters defined in company ITRM system 80 to public ITRM system 84.

Information exchange, e.g. data synchronizations between and among company ITRM system 80, vendor ITRM system 82, and public ITRM system 84 may be executed by one or data synchronization or integration components in each of the respective systems. As noted above, company ITRM system 80 and vendor ITRM system 82 are connected to one another by company/vendor ITRM integration network 86 and both systems are connected to public ITRM system 84 by public ITRM integration network 88. Either one or both of company/vendor ITRM integration network 86 and public ITRM integration network 88 may include one or more of a public or private local area network (LAN) or wide area network (WAN) communicating via terrestrial wired or wireless or satellite transport mediums. Integration network 86 and/or network 88 may, in one example, be a packet-based, Internet Protocol (IP) network that communicates over one or more wired or wireless transport mediums including, e.g., Category 5 Ethernet cables and/or Radio Frequency transmissions. Additionally, network 86 and/or network 88 may include, e.g., voiceband or digital subscriber line (DSL) telephone data transmissions over the Plain Old Telephone Systems (POTS) or other narrow or broadband data transport mediums. In another example, integration network 86 and/or network 88 may include dedicated transport mediums including, e.g., an Integrated Services Digital Network (ISDN) or T1 (also referred to as DS1) lines.

One or more of company, vendor, or public ITRM systems 80, 82, 84, respectively, may be implemented on one or more of any number of different types of computing devices of various configurations. For example, the ITRM systems of FIG. 7 may be implemented on one or more workstations, servers, or other stationary computing devices, or combinations thereof. Additionally, some portions of each ITRM system may be implemented on portable computing devices, including, e.g., mobile telephones, personal data assistants (PDAs), laptop, notebook, or netbook computers, or tablet computers.

Although the type and particular configuration of the computing device or devices on which one or more of company, vendor, or public ITRM systems 80, 82, 84, respectively, is implemented may vary, in general, the system device may include one or more programmable processors configured to execute instructions on and retrieve data from and store data on a memory to carry out one or more functions attributed to the ITRM system in this disclosure. The processors employed to execute the functions of any of the ITRM systems of FIG. 7 may each include one or more processors, such as one or more microprocessors, digital signal processors (DSPs), application specific integrated circuits (ASICs), field programmable gate arrays (FPGAs), programmable logic circuitry, and the like, either alone or in any suitable combination.

The memory of the computing device or devices on which any of company, vendor, or public ITRM systems 80, 82, 84, respectively, of FIG. 7 is implemented may include separate memories for storing programming instructions, ITRM resource data, resource parameters and parameter data, information related to systems and external ITRM data integrations and synchronizations, and any other information used by any of the ITRM systems or another system connected to or associated with the systems. In some examples, the memory of the computing device or devices on which any of the ITRM systems are implemented stores program instructions that, when executed by a processor, cause the processor and the system to perform the functions attributed to them in this disclosure.

Not only may any of company, vendor, or public ITRM systems 80, 82, 84, respectively, of FIG. 7 be implemented on a variety of types of hardware devices with various physical configurations, but the device or devices on which the systems are implemented may also include a variety of software configurations. For example, any of the ITRM systems of FIG. 7 may be implemented on a computing device or a number of devices that are configured to operate based on one of a variety of different operating systems, including, e.g., proprietary systems like Microsoft's Windows, Apple's MAC OS, or open source systems like UNIX, Linux, or Google's Chrome or Android.

The ITRM systems of FIG. 7, i.e. company, vendor, or public ITRM systems 80, 82, 84, respectively, may employ a number of different mechanisms to enable user interaction with the system. In general, however, each of the ITRM systems may include a user interface (UI), including, e.g., a graphical user interface (GUI) that includes a variety of input and output controls. In some examples, the ITRM system may include a GUI from which users may retrieve information from and add information to the system. The GUI of any of the ITRM systems of FIG. 7 may be implemented via a variety of platforms, including, e.g., the GUI may be presented via operating system applications, web-based applications in a web browser, or combinations the types of application platforms.

FIG. 8 is a schematic diagram of an example ITRM system architecture in which ITRM systems employed by multiple companies are located on a network external to the infrastructures of both of the companies. The example of FIG. 8 includes company 1 ITRM system 100, company 2 ITRM system 102, vendor ITRM system 82, and public ITRM system 84. Company 1 ITRM system 100, company 2 ITRM system 102, and vendor ITRM system 82 are connected by company/vendor ITRM integration network 86. Company 1 ITRM system 100, company 2 ITRM system 102, and vendor ITRM system 82 are connected to public ITRM system 84 by public ITRM integration network 88. In contrast to the example of FIG. 7, the example of FIG. 8 includes company 1 ITRM system 100 and company 2 ITRM system 102, and both company systems are located on an external network along with vendor ITRM system 82. Although the deployment model of the example of FIG. 8 differs from that of FIG. 7, the individual ITRM systems, i.e. company 1 ITRM system 100, company 2 ITRM system 102, vendor ITRM system 82, and public ITRM system 84, and the connections and communications between and among the systems may be configured and function in a manner similar to that described above with reference to FIG. 7.

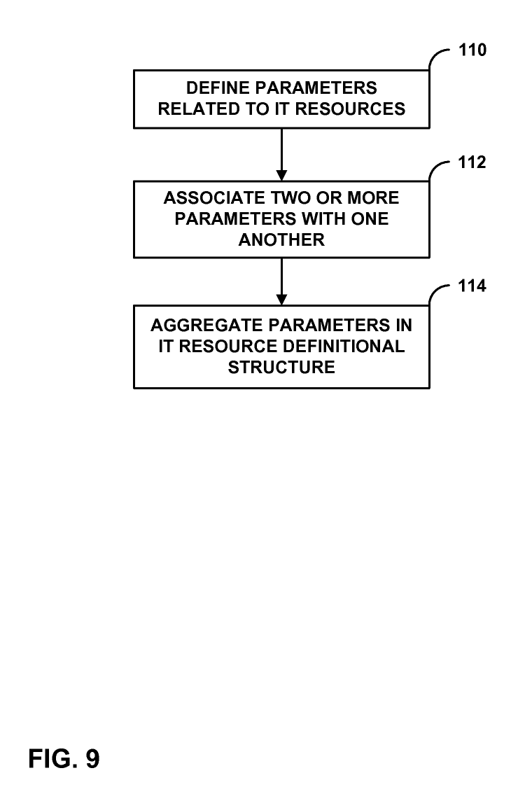

In addition to employing an ITRM system or carrying out a method to define and manage a particular IT infrastructure including a number of particular IT resources, e.g. as described above with reference to example ITRM system 10 of FIG. 1, in some cases it may be useful to generate and store a generic definitional structure by which a variety of types of IT resources may be organized, aggregated, and managed. FIG. 9 is a flowchart of an example method including defining a number of parameters related to a number of different types of IT resources (110), associating each parameter with at least one example of the parameter (112), and aggregating the parameters in an IT resource definitional structure by which any one of the types of IT resources can be defined by associating the IT resource with at least one of the parameters (114).

As described above, examples according to this disclosure organize a variety of different types of IT resources and, in some examples, the work associated with these resources according to a common definitional structure that facilitates a holistic approach to managing IT resources within and work associated with an IT infrastructure. The method of FIG. 9 illustrates an example process by which such an IT resource definitional structure may be generated. The example of FIG. 9 includes, in a similar manner to the example method of managing IT resources of FIG. 2, defining a number of parameters related to IT resources (50). A variety of parameters that relate to various types of IT resources may be defined, including, e.g., one or more technologies, skills, and standards. Additionally, in some examples, technologies and/or standards may include technology and standard releases, respectively. In another example, the technologies parameter may include one or more technology release sets and/or technology editions.

As described above with reference to ITRM system 10 of FIG. 1, technologies may include, e.g., various types of platforms, frameworks, languages, or other foundational technologies, or various off-the-shelf software systems. In some examples, skills may represent a combination of particular types of technologies and particular roles taken on by people in the delivery of a service. Skills may also be more directed toward various types of roles that are generic to any particular technology. In some examples, standards are associated with and promulgated by industry organizations that generally operate independent of particular types of technologies or IT systems. In other examples, standards are associated with particular types of technologies and/or IT systems.

In some examples, other IT resource parameters in addition to or in lieu of technologies, skills, and standards may also be defined, including, e.g., vendors and classifiers. In one example, IT resources may be defined not only by the technologies and standards upon which they depend or are based, but also by the company or other organization that produces and sells the technology or manages and governs the standard. For example, although previously produced by PeopleSoft, the company, the PeopleSoft Enterprise technology is now owned by Oracle, Inc., both of which may be associated with the PeopleSoft Enterprise technology as an example of the vendors parameter. Additionally, in some examples, technologies may be grouped into categories in the classifiers parameter, examples of which may include, e.g., API, Application Server, Web Server, Data Access Method, and other categories by which a number of different technologies may be grouped.

In addition to defining a number of IT resource parameters (110), the method of FIG. 9 includes associating two or more of the parameters with one another (112). For example, a technology may be associated with one or more skills and/or standards. In one example, the technology may also be associated with one or more vendors and/or classifiers. For example, the BEA WebLogic Server technology may be associated with the J2EE Architecture and Development skills and the J2EE standard. The technology BEA WebLogic Server may also be associated with the vendor BEA and the technology classifier Commercial Software. In another example, CA Datacom technology may be associated with the CA Ideal Development and SQL Development skills and the SQL standard. CA Datacom may also be associated with CA, Inc. the vendor and the classifiers Mainframe, Database Management System (DBMS), and Commercial Software.

The method of FIG. 9 also includes aggregating the parameters in an IT resource definitional structure by which any one of the types of IT resources can be defined by associating the IT resource with at least one of the parameters (114). Aggregating the parameters and any associations between parameters in the IT resource definitional structure (114) generally refers to generating a record of the data organized according to the definitional structure. For example, aggregating the parameters in the IT resource definitional structure may include storing the parameters in an off-the-shelf, open source, or proprietary relational database or any other data storage and retrieval mechanism appropriate for storing, searching, and relating the parameters according to the definitional structure.

In some examples it may be beneficial to provide the IT resource definitional structure generated by, e.g. the example method of FIG. 9 to a range different individuals and/or organizations. Such individuals and organizations may leverage the IT resource definitional structure to manage a variety of different types of IT resources related to, e.g., services provided by an individual or company, or an IT infrastructure managed within a company or other organization. The architectural implementations illustrated in and described with reference to FIGS. 7 and 8 provide two examples in which an IT resource definitional structure that is generic to a variety of different types of IT resources is leveraged by a company and/or a vendor of that company. In particular, public ITRM system 84 may be a publicly accessible and, in some examples, editable ITRM system that generates and stores the IT resource definitional structure, e.g. generated by the method of FIG. 9. As described with reference to the examples of FIGS. 7 and 8, public ITRM system 84 may be employed to synchronize or otherwise exchange information with other systems used to manage IT resources, e.g. ITRM system 10 of FIG. 1.

In some examples including public ITRM system 84, or another similar system, one or more user groups may be defined to manage and maintain the publicly accessible system. For example, one group of users may be classified as contributors and authorized to submit changes to the IT resource definitional structure of public ITRM system 84. Additionally, a second group of users may be classified as editors and may be authorized to review and approve or deny the changes to the IT resource definitional structure of ITRM system 84 submitted by a contributor. In some examples, editors may also be authorized to submit changes to the IT resource definitional structure of public ITRM system 84. Example changes to the IT resource definitional structure of public ITRM system 84, or another similarly configured system, include additions, changes, and deletions of one or more of the parameters of the definitional structure.

Although the foregoing examples have been described in the context of organizing IT resources for the purpose of managing an IT infrastructure of an organization, the techniques developed in these examples may be applied in a variety of other contexts. For example, a consulting company may employ an ITRM system in accordance with this disclosure to manage a team or a number of teams of consultants that the company hires out to companies to provide various contracted IT services. In one example, a consulting company or other IT service provider may employ an ITRM system to define a number of parameters related to a number of different types of IT resources including at least systems and people, associate a number of IT resources with the parameters, and assign one or more people to work related to at least one system.

In another example, a technology product company may employ an ITRM system in accordance with this disclosure to manage the release of an IT product, e.g. a commercial software application. For example, the technology product company may employ an ITRM system to define a number of parameters related to a number of different types of IT resources including at least systems and people, associate a number of IT resources with the parameters, and assign one or more people to work related to an IT product. The IT product developed by the technology product company may be based or otherwise depend on and associated with one or more of the IT resource parameters defined in the ITRM system. As such, assigning people to work on the product may be based on the differences and similarities between the IT resource parameters associated with a person and the parameters associated with the IT product or upon which the product is based or otherwise depends. The ITRM system applied to a product or service company may employ some of the other functions or applications described above. In one example, snapshots of the IT product defined in the ITRM system may be employed to model “what-if” scenarios regarding the ability to sell or deliver the product from a sales or engineering perspective.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

Various examples have been described. These and other examples are within the scope of the following claims.

1. A method of managing information technology (IT) resources comprising:
defining, by a computing device, a plurality of parameters related to IT resources;
associating, by a computing device, an IT resource with at least one of the parameters; and
aggregating, by a computing device, a plurality of IT resources as an IT infrastructure, wherein each of the IT resources of the IT infrastructure is associated with at least one of the parameters.

2. The method of claim 1, wherein the parameters comprise at least one of technologies, skills, or standards.

3. The method of claim 1, wherein the IT resources comprise a plurality of types of IT resources.

4. The method of claim 3, wherein the types of IT resources comprise at least systems and people.

5. The method of claim 4, wherein the parameters for systems comprise at least one of organizations, capabilities, actors, connections, geography, technologies, skills, or standards.

6. The method of claim 4, wherein the parameters for people comprise at least one of projects, positions, roles, responsibilities, technologies, skills, or standards.

7. The method of claim 4 further comprising associating, by a computing device, one or more systems and one or more people with one another.

8. The method of claim 4 further comprising associating, by a computing device, one or more systems with one another.

9. The method of claim 4 further comprising associating, by a computing device, one or more people with one another.

10. The method of claim 4 further comprising determining, by a computing device, a relevancy between at least one of a person and a system, two or more systems, or two or more people.

11. The method of claim 10, wherein determining a relevancy comprises comparing the at least one of the parameters associated with each of the at least one of a person and a system, two or more systems, or two or more people to one another.

12. The method of claim 1 further comprising determining, by a computing device, a relevancy between two or more IT resources.

13. The method of claim 12, wherein determining a relevancy comprises comparing the at least one of the parameters associated with each of the two or more IT resources to one another.

14. The method of claim 1 further comprising:
storing, by a computing device, an instance of the IT infrastructure at a point in time; and
comparing, by a computing device, two or more instances of the IT infrastructure at two or more points in time.

15. The method of claim 14, wherein comparing two or more instances of the IT infrastructure comprises comparing two or more instances of the IT infrastructure at two or more points in time in the past.

16. The method of claim 14 further comprising:
simulating, by a computing device, at least one change to the IT infrastructure; and
storing, by a computing device, the simulated instance of the IT infrastructure.

17. The method of claim 16, wherein comparing two or more instances of the IT infrastructure comprises comparing the simulated instance of the IT infrastructure and an instance of the IT infrastructure at a point in time without the at least one simulated change to the IT infrastructure.

18. The method of claim 16, wherein simulating at least one change to the IT infrastructure comprises at least one of:
at least one of adding, removing, or changing an IT resource from the IT infrastructure; or
at least one of adding, removing, or changing at least one of the parameters related to IT resources.

19. The method of claim 1 further comprising:
comparing, by a computing device, the at least one of the parameters associated with each IT resource to the at least one of the parameters associated with all of the other IT resources of the IT infrastructure; and
identifying, by a computing device, two or more IT resources with at least one of the at least one of the parameters in common as redundant IT resources.

20. The method of claim 19 further comprising removing, by a computing device, at least one of the redundant IT resources from the IT infrastructure.

21. The method of claim 19 further comprising:
storing, by a computing device, an instance of the IT infrastructure including all the redundant IT resources;
simulating, by a computing device, the IT infrastructure with at least one of the redundant IT resources removed; and
comparing, by a computing device, the simulated instance of the IT infrastructure with the at least one of the redundant IT resources removed and the instance of the IT infrastructure including all the redundant IT resources.

22. The method of claim 1 further comprising identifying an IT resource for removal from the IT infrastructure.

23. The method of claim 22 further comprising:
comparing, by a computing device, the at least one of the parameters associated with the IT resource identified for removal to the at least one of the parameters associated with all of the other IT resources of the IT infrastructure; and
identifying, by a computing device, at least one IT resource with at least one of the at least one of the parameters in common with at least one of the at least one of the parameters associated with the IT resource identified for removal.

24. The method of claim 22 further comprising:
storing, by a computing device, an instance of the IT infrastructure including the IT resource identified for removal;
simulating, by a computing device, the IT infrastructure with the IT resource identified for removal removed; and
comparing, by a computing device, the simulated instance of the IT infrastructure with the IT resource identified for removal removed and the instance of the IT infrastructure including the IT resource identified for removal.

25. The method of claim 1 further comprising:
defining, by a computing device, a job requisition comprising at least one of the parameters; and
comparing, by a computing device, the at least one of the parameters of the job requisition and the at least one of the parameters associated with at least one of the IT resources of the IT infrastructure,
wherein the at least one of the IT resources of the IT infrastructure with which the job requisition is compared comprises at least one person.

26. The method of claim 25 further comprising selecting one person of the IT infrastructure based on the comparison of the at least one of the parameters of the job requisition and the at least one of the parameters associated with the selected person.

27. The method of claim 25, wherein the at least one of the parameters of the job requisition and the at least one person of the IT infrastructure comprises at least one of projects, positions, roles, responsibilities, technologies, skills, or standards.

28. The method of claim 1 further comprising defining, by a computing device, a project comprising at least one change to the IT infrastructure and at least one job description, wherein the job description comprises at least one of the parameters.

29. The method of claim 28, wherein the at least one change to the IT infrastructure comprises at least one of:
at least one of adding, removing, or changing an IT resource from the IT infrastructure; or
at least one of adding, removing, or changing at least one of the parameters related to IT resources.

30. The method of claim 28 further comprising defining at least one job requisition corresponding to the at least one job description of the project, wherein the job requisition comprises the at least one of the parameters of the job description.

31. The method of claim 28 further comprising:
comparing, by a computing device, at least one of the parameters of the at least one job requisition and the at least one of the parameters associated with at least one of the IT resources of the IT infrastructure,
wherein the at least one of the IT resources of the IT infrastructure with which the at least one job requisition is compared comprises at least one person.

32. The method of claim 31 further comprising selecting one person of the IT infrastructure based on the comparison of the at least one of the parameters of the at least one job requisition and the at least one of the parameters associated with the selected person.

33. The method of claim 28, wherein the at least one of the parameters of the at least one job requisition and the at least one person of the IT infrastructure comprises at least one of projects, positions, roles, responsibilities, technologies, skills, or standards.

34. The method of claim 28, wherein a plurality of the IT resources of the IT infrastructure comprise a plurality of people and further comprising:
defining, by a computing device, a team of people comprising a plurality of people of the IT infrastructure; and
comparing, by a computing device, the at least one of the parameters of the at least one job requisition and the at least one of the parameters associated with each person of the team.

35. The method of claim 34 further comprising selecting one team of people based on the comparison of the at least one of the parameters of the at least one job requisition and the at least one of the parameters associated with each person of the team.

36. The method of claim 1 further comprising generating, by a computing device, a visualization of the IT infrastructure comprising at least one of the IT resources of the IT infrastructure.

37. The method of claim 36, wherein the IT resources of the IT infrastructure comprise different types of IT resources comprising at least systems and people, wherein the parameters for systems comprise at least one of organizations, capabilities, actors, connections, geography, technologies, skills, or standards, and wherein the parameters for people comprise at least one of projects, positions, roles, responsibilities, technologies, skills, or standards.

38. The method of claim 36, wherein generating a visualization of the IT infrastructure comprises generating a map comprising at least one of the IT resources of the IT infrastructure and at least one of the at least one of the parameters associated with the at least one of the IT resources.

39. The method of claim 38, wherein the map comprises at least one system of the IT infrastructure visually associated at least with an organization.

40. The method of claim 39, wherein the map comprises the at least one system of the IT infrastructure visually associated with the organization and at least one of a capability or an actor.

41. The method of claim 38, wherein the map comprises at least one person of the IT infrastructure visually associated with at least one of a system of the IT infrastructure, a project, a position, a role, or a responsibility.

42. The method of claim 36, wherein generating a visualization of the IT infrastructure comprises generating a map comprising two or more systems and one or more connections between the two or more systems.

43. An information technology (IT) resource management system comprising:
at least one programmable processor; and
computer-readable storage medium storing instructions causing the at least one programmable processor to execute:
a systems module in which at least one IT system is defined at least by at least one parameter selected from a plurality of predetermined parameters related to IT resources;
a people module in which at least one person is defined at least by at least one parameters selected from the plurality of predetermined parameters; and
a work module in which a project is defined at least as one or more changes to at least one IT system facilitated by at least one person.

44. An information technology (IT) resource management system comprising:
means for defining a plurality of parameters related to IT resources;
means for associating an IT resource with at least one of the parameters; and
means for aggregating a plurality of IT resources as an IT infrastructure, wherein each of the IT resources of the IT infrastructure is associated with at least one of the parameters.

45. Computer-readable storage medium storing instructions for causing a programmable processor to:
define a plurality of parameters related to IT resources;
associate an IT resource with at least one of the parameters; and
aggregate a plurality of IT resources as an IT infrastructure, wherein each of the IT resources of the IT infrastructure is associated with at least one of the parameters.

46. A method of managing information technology (IT) resources comprising:
defining, by a computing device, a plurality of parameters related to a plurality of different types of IT resources comprising at least systems and people;
associating, by a computing device, an IT resource with at least one of the parameters; and
aggregating, by a computing device, a plurality of IT resources as an IT infrastructure, wherein each of the IT resources of the IT infrastructure is associated with at least one of the parameters.

47. A method of managing information technology (IT) resources comprising:
defining, by a computing device, a plurality of parameters related to IT resources, wherein the parameters comprise at least one of technologies, skills, or standards;
associating, by a computing device, an IT resource with at least one of the parameters; and
aggregating, by a computing device, a plurality of IT resources as an IT infrastructure, wherein each of the IT resources of the IT infrastructure is associated with at least one of the parameters.

48. A method of managing information technology (IT) resources comprising:
defining, by a computing device, a plurality of parameters related to a plurality of different types of IT resources, wherein the types of IT resources comprise at least systems and people and the parameters comprise at least one of technologies, skills, or standards;
associating, by a computing device, an IT resource with at least one of the parameters; and
aggregating, by a computing device, a plurality of IT resources as an IT infrastructure, wherein each of the IT resources of the IT infrastructure is associated with at least one of the parameters.

49. A method comprising:
defining, by a computing device, a plurality of parameters related to a plurality of different types of IT resources;
associating, by a computing device, two or more of the parameters with one another; and
aggregating, by a computing device, the parameters in an IT resource definitional structure by which any one of the types of IT resources can be defined by associating the IT resource with at least one of the parameters.

50. The method of claim 49, wherein the parameters comprise at least one of technologies, skills, standards, vendors, or classifiers.

51. The method of claim 49, wherein the types of IT resources comprise at least one of systems or people.

52. The method of claim 49 further comprising storing the IT resource definitional structure comprising the parameters in a publicly accessible data repository.

53. The method of claim 52 further comprising authorizing a first group of users to submit a change to the IT resource definitional structure.

54. The method of claim 53 further comprising authorizing a second group of users to approve the change to the IT resource definitional structure submitted by a user of the first group of users.

55. The method of claim 54, wherein the change to the IT resource definitional structure comprises at least one of an addition, change, or deletion of one or more of the parameters of the IT resource definitional structure.
